(19) United States
(12) Patent Application Publication
(10) Pub. No.: US 2026/0303509 A1
(43) Pub. Date: Oct. 1, 2026

(54) METHOD AND APPARATUS TO REDUCE USER OVERHEAD AND OPTIMIZE TOPOLOGY CHANGE HANDLING DURING CONTROL PLANE RESTARTS

(71) Applicant: CIENA CORPORATION, Hanover, MD (US)

(72) Inventors: Sumit Hans, Faridabad (IN); Ashish Agrahari, Fatehpur (IN); Nitish Pareek, Gurgaon (IN); Ankit Kumar Choudhary, Gurgaon (IN)

(73) Assignee: CIENA CORPORATION, Hanover, MD (US)

(21) Appl. No.: 19/212,960

(22) Filed: May 20, 2025

(30) Foreign Application Priority Data
Mar. 31, 2025 (IN) 202541031515

(51) Int. Cl. H04L 45/02; H04L 45/50

(52) U.S. Cl. CPC H04L 45/026; H04L 45/02; H04L 45/50

(57) ABSTRACT

Aspects of the subject disclosure may include, for example, providing a Hello packet between a first node and a second node, where the Hello packet includes one of restart information with a maximum restart timer or abort information with an abort instruction, and where the first node is operating according to one of OSPF protocol or IS-IS protocol. Other embodiments are disclosed.

### CROSS REFERENCE TO RELATED APPLICATIONS

This application claims priority to IN Patent Application Serial No. 202541031515 filed on Mar. 31, 2025. All sections of the aforementioned application are incorporated herein by reference in their entirety.

### FIELD OF THE DISCLOSURE

The subject disclosure relates to a method and apparatus to reduce user overhead and optimize topology change handling during control plane restarts.

### BACKGROUND

In modern networking environments, protocols play an important role in ensuring efficient and reliable data routing. These protocols facilitate the exchange of routing information between routers, enabling them to determine optimal paths for data transmission. However, challenges arise during unplanned restarts of network nodes, which can disrupt the continuity of data flow and lead to significant network instability. Current mechanisms for handling such restarts often require manual configuration of timers and rely on cumbersome processes for detecting topology changes, which can be inefficient and prone to errors.

Existing solutions often fall short in providing seamless recovery during unplanned restarts, as they lack the capability to efficiently notify and manage restart-related information across network nodes. This can result in traffic loss and increased overhead due to the manual intervention required to adjust network settings. Additionally, the current methods for detecting and responding to topology changes during restarts are not optimized, leading to potential delays and disruptions in network operations.

Timing issues can arise due to restarting nodes taking longer to come up due to multiple reasons such as: slowness of the different devices that are deployed in network; or a scaled configuration present on the restarting node causing a longer time to reboot. This can lead to a helper node timing out on a Dead Timer even before it receives the event to enter into Graceful Restart phase and thus eventually will start to clean up the neighbors and corresponding routes thus leading to failure of overall restart mechanism.

Further, a topology change in the network (e.g., beyond the helper and restarting nodes) may occur and a restarting node may be unable to determine this topology change, such as not having the ability to compare Link-State Database (LSDB) entries before and after the restart. This unknown topology change can lead to routing problems. Additionally, a node maintaining the entire LSDB in persistent memory during restarts and then during the Graceful Restart (GR) comparing the pre-restart LSDB with the current LSDB is an inefficient process and resource intensive.

### BRIEF DESCRIPTION OF THE DRAWINGS

Reference will now be made to the accompanying drawings, which are not necessarily drawn to scale, and wherein:

FIG. 1A is a block diagram illustrating an exemplary, non-limiting embodiment of data communicated in accordance with various aspects described herein utilizing Open Shortest Path First (OSPF) protocol.

FIG. 1B is a block diagram illustrating an exemplary, non-limiting embodiment of data that can be communicated in accordance with various aspects described herein utilizing Intermediate System to Intermediate System (IS-IS) protocol.

FIG. 1C is a block diagram illustrating an exemplary, non-limiting embodiment of data that can be communicated in accordance with various aspects described herein utilizing IS-IS protocol.

FIG. 2 is a block diagram illustrating an exemplary, non-limiting embodiment of a communications system in accordance with various aspects described herein.

FIGS. 3A and 3B depict illustrative embodiments of a method in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for using a restart Time/Length/Value (TLV) data block to facilitate managing restarts and managing aborts in a restart. The TLV can be used by all OSPF or IS-IS GR capable nodes in the network. This TLV can be sent with each Hello Packet. The TLV can include restart support capabilities of the sending router. In one embodiment, the restart capabilities can be made configurable. In other embodiments, various nodes can be updated to operating as a helper node in conjunction with any new Hello packet.

In one or more embodiments, one or more of the components, functions, data formats or other features of one or more of the embodiments described herein can be utilized with other routing protocols or routing techniques, which may generally include RIP (Routing Information Protocol) or EIGRP (Enhanced Interior Gateway Routing Protocol).

In one embodiment, the TLV (e.g., which may be sent to various nodes including a restarting node(s)) can include abort information which may have a GR abort indication along with a reason. In effect, this can result in faster convergence during topology change events. Other embodiments are described in the subject disclosure.

The system and methodology described herein addresses at least two issues in OSPF and IS-IS protocols (which may occur in other routing protocols as well) during unplanned restarts. The system can introduce a new Graceful Restart TLV (GR-TLV) in OSPF Hello packets, which allows for the exchange of important GR-related information, such as the maximum restart timer, or GR abort indications, or both, between nodes. This mechanism enables helper nodes to better manage timing and topology changes, reducing the need for manual configuration of Dead Timers and enhancing network stability. Additionally, the system proposes enhancements to the existing IS-IS restart TLV (and/or use of a new IS-IS restart TLV), incorporating new flags to convey GR information, thereby optimizing the handling of topology changes and minimizing traffic disruption. This approach not only streamlines the GR process but also provides a more efficient and scalable solution for low-end devices with limited persistent memory.

One or more aspects of the subject disclosure include a method comprising receiving, by a helper node, a Hello packet from a restarting node, where the Hello packet includes restart information comprising a maximum restart timer. The method can include storing, by the helper node, the restart information; and based on the restart information, operating, by the helper node, a timer (e.g., a secondary timer) and refraining from clearing neighborship and respective routing entries during a timer period (e.g., an additional or secondary timer period) which follows expiration of a dead time period and is prior to expiration of the timer. The method can include maintaining, by the helper node, traffic flow during the timer period to allow the restarting node to attempt to complete a restart process; and monitoring, by the helper node, for receipt of a Link-State Advertisement (LSA) at the helper node from the restarting node. The method can include, responsive to receiving the LSA within the timer period, entering, by the helper node, a restart recovery phase thereby continuing to function as the helper node for the restarting node; or responsive to expiration of the timer period prior to the receiving of the LSA, clearing, by the helper node, the neighborship and respective routing entries.

One or more aspects of the subject disclosure include a method comprising receiving, by a helper node, a Hello packet (or other control/routing packet) from a restarting node, where the Hello packet includes restart information comprising a maximum restart time or timer. The method can include storing, by the helper node, the restart information; and based on expiration of a Dead Timer and the restart information, initiating, by the helper node, a secondary timer and refraining from clearing neighborship and respective routing entries. The method can include maintaining, by the helper node, traffic flow during a secondary timer period of the secondary timer to allow the restarting node to attempt to complete a restart process; and monitoring, by the helper node, for receipt of a Link-State Advertisement (LSA) at the helper node from the restarting node. The method can include, responsive to receiving the LSA within the secondary timer period, entering, by the helper node, a restart recovery phase thereby continuing to function as the helper node for the restarting node; or responsive to expiration of the secondary time period prior to the receiving of the LSA, clearing, by the helper node, the neighborship and respective routing entries.

One or more aspects of the subject disclosure are a method that includes providing, by a restarting node, a Hello packet to a helper node, where the Hello packet includes restart information with a maximum restart timer; commencing a restart; and commencing a recovery phase.

One or more aspects of the subject disclosure include a device operating as a first node, and comprising a processing system including a processor; and a memory that stores executable instructions that, when executed by the processing system, facilitate performance of operations. The operations can include providing a Hello packet to a second node, where the Hello packet includes one of restart information with a maximum restart timer or abort information with an abort instruction, and where the first node is operating according to one of OSPF protocol or IS-IS protocol.

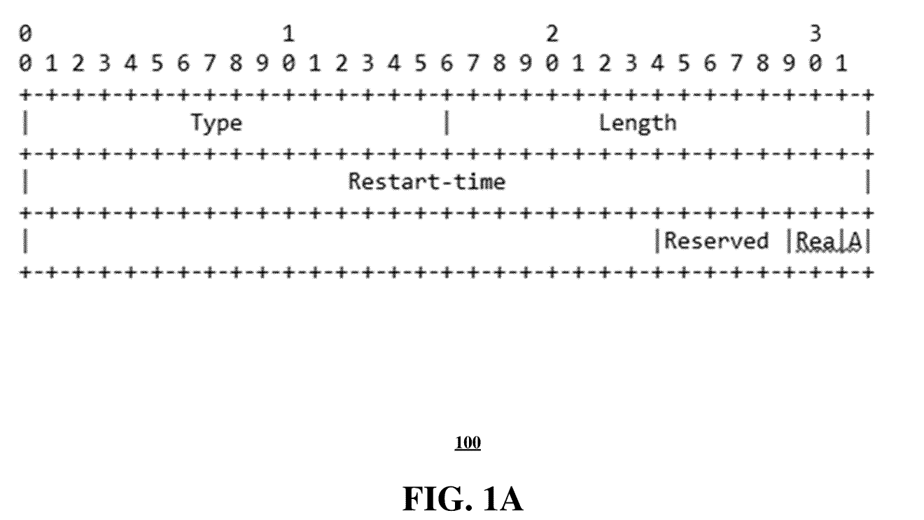

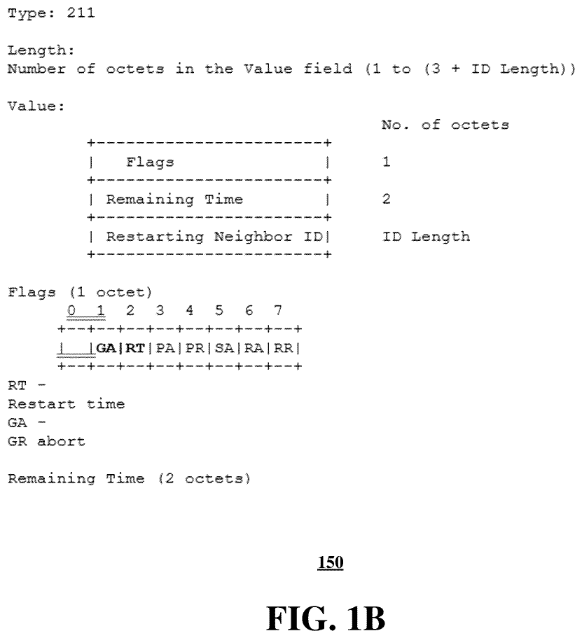

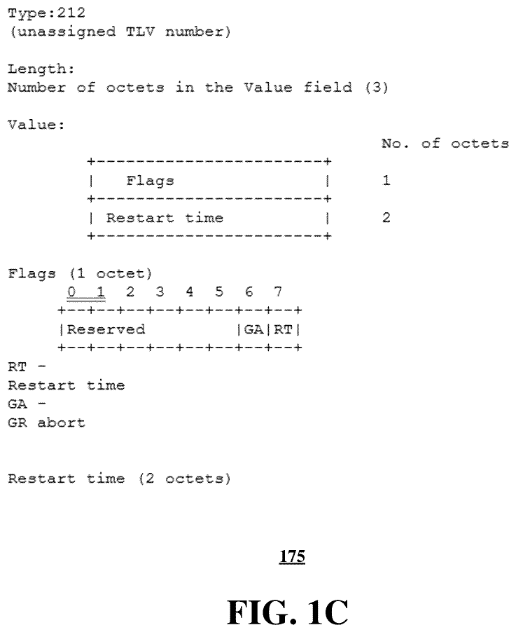

FIG. 1A illustrates an exemplary, non-limiting embodiment of data 100 (or a format therefor) that can be communicated in accordance with various aspects described herein utilizing OSPF protocol. OSPF is a link-state routing protocol used in IP networks to determine the best path for data packets to travel from one node to another. OSPF routing works through a series of steps that involve the exchange of information between routers to build a comprehensive map of the network topology. OSPF routers discover other OSPF routers on the same network segment by sending Hello packets. These packets are sent periodically to a multicast address, such as 224.0.0.5 (AllSPFRouters), on broadcast and/or point-to-point networks. When a router receives a Hello packet, it checks the packet for compatibility (e.g., same OSPF area, authentication, etc.). If compatible, the routers establish a neighbor relationship.

Not all neighbors become fully adjacent. Adjacencies are formed based on the network type (e.g., point-to-point, broadcast, etc.). On broadcast networks, a Designated Router (DR) and a Backup Designated Router (BDR) are elected to minimize the number of adjacencies. All routers on the network can form adjacencies with the DR and BDR. On point-to-point networks, routers can form adjacencies directly with each other. Once adjacencies are established, routers can exchange LSAs to share information about their links and the state of those links. LSAs contain information about the router's interfaces, the cost of the links, and the state of the links (e.g., up or down). Each router collects LSAs from its neighbors and builds an LSDB. The LSDB can contain a complete map of the network topology. Routers use the Shortest Path First (SPF) algorithm, also known as Dijkstra's algorithm, to calculate the shortest path to each destination based on the information in the LSDB.

Using the SPF algorithm, each router calculates the Shortest Path Tree (SPT) with itself as the root. The SPT represents the shortest paths to all other routers in the network. The cost of a path is determined by the sum of the costs of the individual links along the path. The cost is typically based on link bandwidth. From the SPT, each router builds its routing table, which contains the best paths to each destination network. The routing table entries include the destination network, the next-hop router, and the outgoing interface. OSPF uses a reliable flooding mechanism to ensure that all routers in the network have consistent and up-to-date LSDBs. When a router detects a change in the network topology (e.g., a link goes down), it generates a new LSA and floods it to all its neighbors. The neighbors, in turn, flood the LSA to their neighbors, and so on, until all routers have received the updated LSA. Convergence is the process by which all routers in the network update their LSDBs and routing tables to reflect the current network topology. OSPF is designed to converge quickly, minimizing the time during which the network may experience routing inconsistencies. By following these steps, OSPF tries to ensure that all routers in the network have a consistent view of the network topology and can make informed routing decisions. This results in efficient and reliable routing of data packets across the network.

Data 100 (e.g., including the information described herein in the various embodiments that facilitates managing restarts such as through use of a secondary timer and managing aborts in a restart) can be utilized with Graceful Restart (GR) which is a mechanism within OSPF that allows a router to restart without disrupting the forwarding of packets. This ensures minimal impact on network stability and performance during the restart process. When an OSPF router needs to restart (e.g., due to a software upgrade or a planned maintenance), it initiates the Graceful Restart process. In one or more embodiments, a restarting router would have already exchanged Restart related information (e.g., Restart Time, GR-TLV Support, etc.) prior to Restart with the Helper Node. When the Helper node detects a Time Out due to not receiving a Grace LSA from a Restarting Node after it came back up, then, according to one or more of the embodiments and based on the data 100 and the messaging techniques described herein, the Helper node will start another timer equivalent to the GR Restart Timer as was exchanged by Restarting Node earlier. Once the Helper node receives the Grace LSA, it will enter the GR Helper mode and will stop this additional timer (which has been provisioned according to the one or more embodiments described herein) and continue to run the Helper Timer as usual. In this mode, the neighbors continue to forward packets based on the last known routing information and maintain the adjacency with the restarting router. One advantage of OSPF Graceful Restart is that it allows a router to restart without causing a significant disruption in the network. By maintaining the forwarding state and minimizing topology changes during the restart, the network can continue to operate smoothly, ensuring high availability and reliability.

The data 100 of FIG. 1A helps each OSPF node to exchange restart information such as a max restart timer or time period (and this information can be stored by a helper node) using the Hello packets received from a restarting node. For example, when the restarting node goes for a restart and if it takes longer time to come back up, a helper node upon expiry of a Dead Timer can check if its peer was supporting an extended restart timer (e.g., using earlier saved information in data 100 from the Hello packet) and if so then the helper node can start another timer (e.g., a secondary timer) which can be of various time periods including an equivalent to the restart timer. In one embodiment, the particular secondary time period can be selected or determined according to various factors including type of device, type of network, historical restart time periods, predicted future restart time periods, and so forth, and can be selected or determined using various techniques including Artificial Intelligence modeling. In this example, this secondary timer causes the helper node to refrain from clearing up or otherwise adjusting the neighborship and/or respective routing entries until expiration of a secondary time period of the secondary timer. Data 100 can be utilized to control or otherwise manage the use of the secondary timer by the helper node(s). In this example, this secondary time period gives the helper node more time to actually realize if its peer has gone for a restart. This will further help to continue the traffic unless or until Graceful Restart fails for some other genuine reason later. In one or more embodiments, the secondary time period can indicate a nominal or maximum amount of time required for the restarting node to complete restart, or at least an amount of time that the secondary node is to wait for such restart before taking actions as described herein.

As will be described herein, if a grace LSA is received from the restarting node by the helper node within this secondary time period then the helper node enters the graceful restart recovery phase and starts to operate as, or otherwise be, a helper node for the restarting node. If no grace LSA is received and the secondary time period expires, then the helper node cleans up the respective neighborship and routes and starts fresh SPF calculations. This mechanism, which is being implemented through exchange of data 100, saves overhead by eliminating the need for a user to manually configure an increase of dead timers on all the OSPF nodes in the network. In one or more embodiments, this process can be applied to any number of helper nodes of a restarting node and/or any number of restarting nodes.

In one embodiment, data 100 can include a new Type/Length/Value (TLV) in OSPF Hello Packets under an LLS Data Block. RFC 5613 dated August 2009 (the disclosure of which is hereby incorporated by reference herein in its entirety) describes OSPF Link-Local Signaling (LLS) and includes a general format for LLS TLVs. The TLV of data 100 can be called a “Graceful Restart TLV” (GR-TLV). In one embodiment, the GR-TLV of data 100 can follow or otherwise comply with the format or requirements of RFC 5613. In one embodiment, all the nodes running OSPF protocol in a network can exchange this new GR-TLV of data 100, such as in an OSPF Hello Packet under the LLS Data block based on their GR capabilities (which can also change such as at run time).

In the context of OSPF, a TLV is a data encoding scheme used to include various pieces of information within protocol packets, such as Hello packets. The TLV format is a flexible and extensible way to encode information, allowing for the inclusion of different types of data without requiring changes to the overall packet structure. The Type field specifies the kind of information being conveyed. It is an identifier that indicates what the value represents. For example, in an OSPF Hello packet, different types might represent different kinds of information such as router ID, network mask, or options. The Length field specifies the length of the Value field in bytes. This allows the receiver to know how many bytes to read for the value. The length may not include the bytes used for the Type and Length fields themselves. The Value field can contain the actual data being conveyed. The format and content of this field can depend on the Type specified. For example, if the Type indicates that the Value is a router ID, the Value field will contain the router ID in a specific format.

In an OSPF Hello packet, TLVs can be used to include various pieces of information that are necessary for establishing and maintaining OSPF neighbor relationships. The use of TLVs allows for greater flexibility and extensibility in the protocol, as new types of information can be added without requiring changes to the basic packet structure. By using the TLV format, OSPF can efficiently encode and transmit various types of information within Hello packets, facilitating the establishment and maintenance of neighbor relationships and ensuring the proper functioning of the OSPF protocol.

The GR-TLV of data 100 can contain useful or key GR-related information which nodes (e.g., helper nodes) need, or otherwise can make use of, during restart scenarios (or at other times). Helper nodes that support this new GR-TLV of data 100 can decode the information exchanged in the GR-TLV and can use this information to support operating as a helper node (more Gracefully) for a restarting node.

As described herein, the GR-TLV of data 100 can include abort information that is utilized by a restarting node to abort a restart (e.g., abort a recovery phase) which can be based on a number of reasons including a change of topology. The GR-TLV can include this abort information in addition to other information, or in addition to a used or unused field reserved for restart time. As further described herein, the abort information (e.g., an abort instruction and an abort reason or description) can be included in a GR-TLV that is sent in a Hello packet from a helper node to a restarting node, such as when a helper node determines or is otherwise informed of a topology change (which can affect the restarting node).

The TLV details and encapsulation mechanism are generally depicted in FIG. 1A and in the example below, however, other formats and information can also be utilized:
TLV type: 34592
Length: 8
Data=>
   Restart time: 32 bits
   GR abort: 1 bit (0x00000001)
   GR abort reason: 2 bits
      GR_ABORT_REASON_TOPOLOGYCHG 1
      GR_ABORT_REASON_TIMEDOUT 2
Description:
   Restart time: 32 bits
   Restart Time is measured in milliseconds. Restarting nodes sends this time to helper. This is max time which Helper node should wait to receive the Grace-LSA from Restarting node.
   GR abort flag: 1 bit
   Helper node can set this bit to indicate GR Abort to the restarting node. GR abort reason: 2 bits
   GR abort reason should be set along with GR abort flag.
   GR_ABORT_REASON_TOPOLOGYCHG:
   If a Helper node has received topology change event during GR recovery of Restarting node then helper node will abort GR recovery and send GR abort with this reason to Restarting node.
   GR_ABORT_REASON_TIMEDOUT:
   If a Helper node has not received grace-LSA and timeout then it can send GR abort with this reason.
   Reserved: 5 bits
   Reserved bits for future use.

Although a same TLV as described above includes capacity for both GR abort information (e.g. to be communicated from a helper node) and restart time information (e.g. to be communicated by a restarting node), other approaches may be used. For example, a first format of TLV (or other message format) may be used for communicating GR abort information, and a second format of TLV (or other message format) may be used for communicating restart time information.

FIG. 1B illustrates an exemplary, non-limiting embodiment of data 150 (or a format therefor) that can be communicated in accordance with various aspects described herein utilizing IS-IS protocol. Data 150 can be utilized in similar ways as data 100 for managing restart and abort procedures of a restarting node (as well as operations of helper node(s) involved in a restart of a restarting node).

The IS-IS protocol is a routing protocol used to determine the best path for data to travel across a network. It is a link-state protocol, meaning it uses information about the state of links in the network to build a complete map of the network's topology. This map is then used to calculate the shortest path to each destination. IS-IS operates at the network layer and is designed to be highly scalable, making it suitable for large and complex networks, such as those found in service provider environments. It is often used in conjunction with the Internet Protocol (IP) and can support both IPv4 and IPv6.

One of the key features of IS-IS is its ability to quickly adapt to changes in the network topology, such as link failures or the addition of new routers. This is achieved through the use of Link State Packets (LSPs), which are flooded throughout the network to ensure all routers have a consistent view of the network. IS-IS is also known for its hierarchical design, which allows for the division of a network into areas. This helps to reduce the amount of routing information that needs to be processed by each router, improving efficiency and scalability. Overall, IS-IS is a robust and efficient protocol that is widely used in large-scale networks.

Data 150 can include an enhancement of an existing restart TLV. IS-IS restart TLV (type 211) is already defined in RFC 8706, the disclosure of which is incorporated by reference herein in its entirety. The enhancement can include new bits (e.g., 2) in an existing flag to send GR information (e.g., restart time and GR abort). As an example, a restart capable node can send this TLV in all IS-IS IIH PDUs along with a restart timer and RT bit set. In this example, a helper node can be informed ahead of time (via the timer(s)) as to how much time it is required to hold an IS-IS adjacency (e.g., neighborship and routing) which allows the restarting node to come online or otherwise send an LSP including a Restart-TLV.

Data 150 can include in some embodiments or under certain circumstances a field for: Remaining Holding Time (in seconds). This field can be included if the “RT” bit is set to inform a max restart time to the helper node. It can be advertised in all IIHs PDUs by GR capable nodes.

As described herein, the TLV of data 150 can also include abort information that is utilized by a restarting node to abort a restart (e.g., abort a recovery phase) which can be based on a number of reasons including a change of topology. As further described herein, the abort information can be included in a TLV of data 150 that is sent in a Hello packet from a helper node to a restarting node, such as when a helper node determines or is otherwise informed of a topology change (which can affect the restarting node).

FIG. 1C illustrates an exemplary, non-limiting embodiment of data 175 (or a format therefor) that can be communicated in accordance with various aspects described herein utilizing IS-IS protocol. Data 175 can be utilized in similar ways as data 100 and/or 150 for managing restart and abort procedures of a restarting node (as well as operations of helper node(s) involved in a restart of a restarting node).

Data 175 can include a new TLV (e.g., an Extended Restart TLV). For example, the Extended Restart TLV can be defined to be included in IIH PDUs along with existing restart TLV (type 211 which can be defined as per RFC 8706 or as described above with respect to FIG. 1B). The TLV of data 175 can provide more GR information exchange between helper and restarting nodes (and/or other nodes or devices). As an example, data 175 can include a Max time in seconds for restarting node to send “RT” bit set on restart TLV to a helper node. It can be advertised in all IIHs PDUs by GR capable node.

As described herein, the TLV of data 175 can also include abort information that is utilized by a restarting node to abort a restart (e.g., abort a recovery phase) which can be based on a number of reasons including a change of topology. As further described herein, the abort information (e.g., an abort instruction and an abort reason or description) can be included in a TLV of data 175 that is sent in a Hello packet from a helper node to a restarting node, such as when a helper node determines or is otherwise informed of a topology change (which can affect the restarting node).

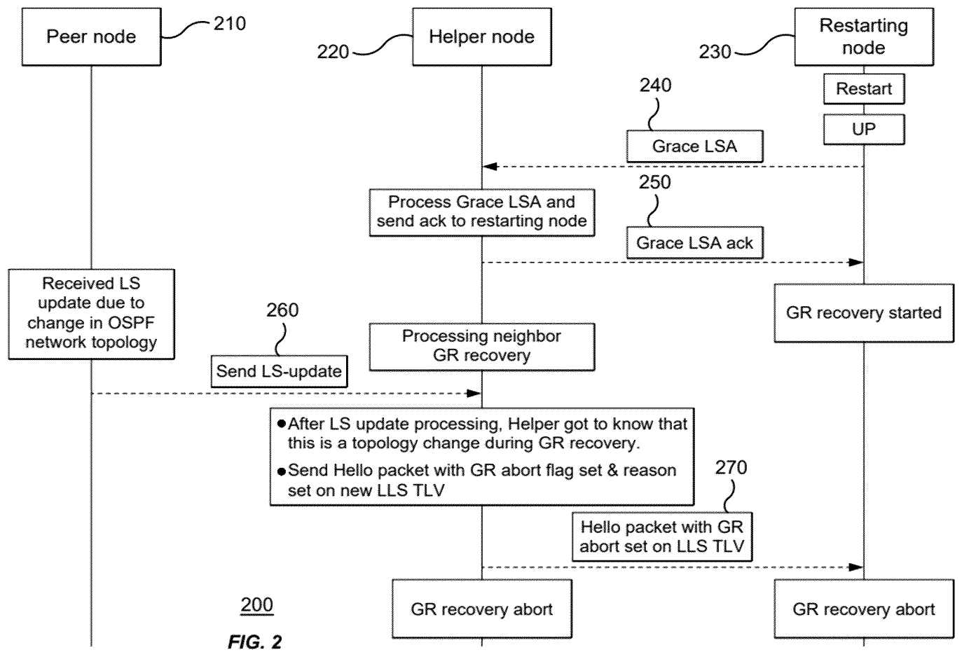

FIG. 2 is a block diagram illustrating an exemplary, non-limiting embodiment of a communications system 200 in accordance with various aspects described herein. System 200 illustrates a communication framework designed to optimize or improve topology change handling and reduce user overhead during unplanned restarts in a network utilizing OSPF or IS-IS protocols. The system 200 can include various components and functionality including a peer node 210, a helper node 220, and a restarting node 230. These nodes can be of various types, including routers, that provide for routing of packets throughout a network. The process performed by system 200 can be based on OSPF or IS-IS protocols, but in this example is described with respect to OSPF. For example, the restarting node 230 can initiate a restart and can send a Grace LSA 240 to the helper node 220. The helper node 220 can process the Grace LSA and can send an acknowledgment 250 back to the restarting node 230, indicating, triggering or otherwise resulting in a start of the Graceful Restart (GR) recovery phase.

The helper node 220 can be important in maintaining network stability by utilizing the Graceful Restart TLV (GR-TLV) information received in Hello packets from the restarting node 230. This information can include the maximum restart timer, which the helper node 220 stores and uses to manage timing and topology changes (and/or notification of topology changes). In one embodiment, if a peer node 210 detects a topology change and sends an LS update 260, the helper node 220 processes this update and determines if it indicates a topology change during the GR recovery. In such cases, the helper node 220 can send a Hello packet 270 with a GR abort flag and abort reason set on the LLS TLV (in the Hello packet) to the restarting node 230, instructing it to abort the GR recovery if necessary.

This mechanism allows the helper node 220 to maintain traffic flow and delay clearing or adjusting of neighborship and routing entries, providing the restarting node 230 with additional time to complete its restart process. If no grace LSA had been received within the secondary timer period, the helper node 220 would have cleared the neighborship and routes, initiating fresh Shortest Path First (SPF) calculations.

The system 200 effectively reduces the need for manual configuration of increased dead timers across the network, optimizing the handling of topology changes and enhancing network reliability. Additionally, the system 200 supports low-end devices with limited persistent memory by utilizing a hybrid memory approach, storing essential restart information in volatile memory and/or less essential data in non-volatile memory to balance speed and resource usage. This comprehensive approach ensures that the network can quickly adapt to topology changes and maintain stability, even in high-traffic scenarios.

System 200 facilitates a helper node 220 obtaining information about the restart timer (e.g., a maximum restart timer) thus making the GR process seamless even for low end or slow devices in a network. This can avoid users manually configuring a dead timer when using GR with OSPF or IS-IS protocols on each of the nodes in the network. This makes the OSPF or IS-IS unplanned restart seamless and more predictable. Topology changes can be detected (or otherwise accounted for) more easily by the restarting nodes. A GR abort procedure is also improved or optimized since the restarting node 230 does not need to perform a comparison of a large amount of information of a Link-State Database (LSDB) to identify a topology change. This restart/abort information (e.g., in a GR-TLV or IS-IS restart TLV) can be extended to include more such GR related information if required or otherwise facilitating procedures within the OSPF or IS-IS protocols, such as a restart.

In the context of OSPF Graceful Restart, the helper node 220 (or helper router) is a neighboring router that assists the restarting router 230 in maintaining network stability and continuity during the restart process. In one embodiment, when an OSPF router 230 needs to restart (e.g., due to a software upgrade or planned maintenance), it initiates the Graceful Restart process by setting the “Restart” bit in the OSPF Hello packets it sends to its neighbors. In one embodiment, neighboring routers 220 can receive the Hello packet with this bit set to indicate that the router supports the new GR-TLV. These neighboring routers can then enter a special mode known as “Helper Mode.”

In Helper Mode, the helper nodes 220 can continue to maintain their adjacency with the restarting router 230. This means they do not tear down the OSPF neighbor relationship, which helps in preserving the network topology and preventing unnecessary recalculations of routing paths. Helper nodes 220 can continue to forward packets based on the last known routing information. This ensures that data traffic is not disrupted and continues to flow smoothly through the network, even though the restarting router 230 is temporarily unable to participate fully in the OSPF protocol.

In one embodiment, when or if a restarting router 230 has not generated and transmitted a Grace LSA to the helper node 220, then the helper node while running the secondary timer will refrain from transmitting any new LSAs to the restarting router. In this example, this can prevent unnecessary updates to the OSPF database and can help maintain network stability. However, detection of a topology change can cause the helper node 220 to send abort instructions to the restarting node 230, which can be included in a Hello packet.

In one embodiment, once the restarting router 230 comes back online, it begins to synchronize its OSPF database with its neighbors, including the helper nodes 220. This can involve exchanging Database Description (DBD) packets and Link-State Request (LSR) packets to ensure that the restarting router has the most up-to-date link-state information.

In one embodiment, after a database synchronization is complete, the restarting router 230 can exit the Graceful Restart state and can resume normal OSPF operations, including generating and processing LSAs. In another embodiment, the helper nodes 220 also exit helper mode and return to their regular OSPF operations.

In one embodiment, if the restarting router 230 fails to complete the Graceful Restart within a specified timeout period that includes the secondary time period as described herein, the helper nodes 220 will exit helper mode and treat the restarting router 230 as a new router. In some instances, this can lead to a temporary delay or disruption in the network as the routing tables are recalculated.

In summary, a helper node 220 plays an important role in ensuring network stability and continuity during an OSPF Graceful Restart by more efficiently managing time requirements for receiving an LSA, more efficiently informing restarting nodes 230 of topology changes, more efficiently causing aborts due to topology changes, maintaining adjacency, forwarding packets, and/or suppressing unnecessary LSA generation. This helps minimize the impact of the restart on the overall network performance.

As described herein, system 200 provides a Hello packet that can inform the restarting node 230 of a topology change and can cause an abort of the recovery phase. Various topology changes can affect OSPF Graceful Restart (GR) including any modifications to the network's structure that impact the routing paths and the connectivity between routers. These changes can disrupt the normal operation of OSPF. When a physical or logical link between two routers goes down, it can cause a topology change. This may result in the need for rerouting traffic and updating the OSPF database to reflect the new network topology. If a router fails or is taken offline, the network must adjust to the absence of that router. This can lead to recalculations of routing paths and updates to the OSPF database.

Introducing new links between routers can change the network topology by providing additional paths for data transmission. OSPF can update its database and routing tables to incorporate these new links. Adding new routers to the network can also affect the topology. OSPF can recognize the new routers, establish adjacencies, and update the routing information accordingly. Changes in the cost (or metric) associated with a link can affect the routing decisions made by OSPF. If the cost of a link increases or decreases, OSPF may need to recalculate the shortest paths and update the routing tables.

Modifications to network segments, such as changes in subnet configurations or the addition/removal of network segments, can impact the OSPF topology. These changes require updates to the OSPF database and routing tables. Changes to the configuration of OSPF routers, such as modifications to OSPF areas, authentication settings, or other protocol parameters, can affect the OSPF topology and require updates to the routing information.

Scheduled maintenance activities, such as software upgrades or hardware replacements, can temporarily disrupt the network topology. OSPF can handle these changes gracefully to minimize the impact on network operations.

During OSPF Graceful Restart, the goal is to minimize or reduce the impact of these topology changes by maintaining the forwarding state and preventing unnecessary updates to the OSPF database. This ensures that the network remains stable and continues to operate smoothly while the restarting router synchronizes its database and resumes normal operations.

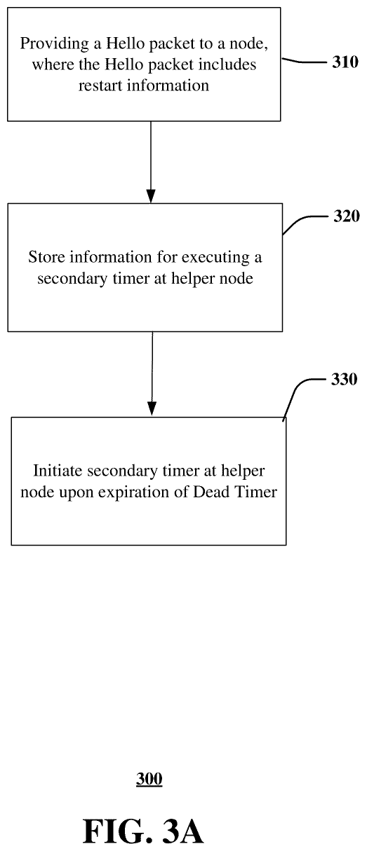

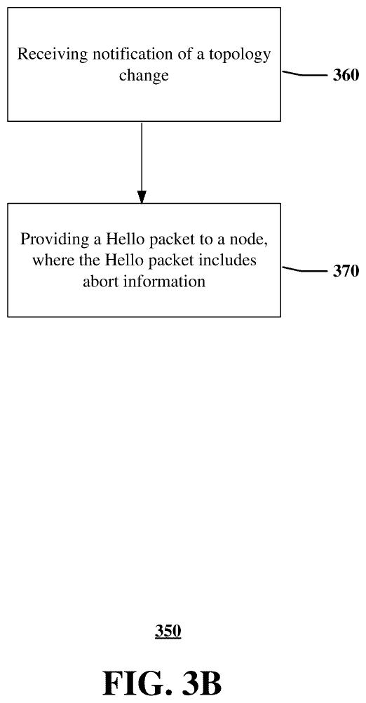

FIG. 3A depicts an illustrative embodiment of a method 300 in accordance with various aspects described herein. Method 300 describes a process for optimizing network stability during unplanned restarts in a network utilizing OSPF or IS-IS protocols. The method 300 can include at 310 a node (e.g., a restarting node) providing a Hello packet to another node (e.g., a helper node), where the Hello packet includes restart information with a maximum restart timer. For example, prior to Restart, each node (e.g., router) can share their respective GR-TLV (or Restart TLV) indicating the support for this new mechanism to each other.

In one embodiment, this Hello packet can be received by the helper node at 320 and stored for future use, where the helper node is responsible for or otherwise facilitates assisting the restarting node during its restart procedure and recovery phase. According to restart information included in the Hello packet, the helper node can store information for utilizing a secondary timer, which under certain conditions can be initiated at 330. As an example, the secondary timer can be initiated at the expiration of a Dead Timer if a Grace LSA (or LSP) has not yet been received from the restarting node. As described herein, during the secondary time period of the secondary timer, the helper node refrains from performing any clean up of neighbor/routes. For instance, the secondary timer can be based on the maximum restart timer information contained within a GR-TLV or IS-IS Restart TLV included in the Hello packet. This secondary timer allows the helper node to maintain traffic flow and delay clearing neighborship and routing entries, providing the restarting node with additional time to complete its restart process. In one embodiment if a grace LSA is then received within this secondary timer period, the helper node enters a Graceful Restart (GR) recovery phase, continuing to function as a helper node for the restarting node. However, if no grace LSA is received and the secondary timer expires, the helper node proceeds to clear the neighborship and routes, initiating fresh Shortest Path First (SPF) calculations.

The method 300 effectively reduces the need for manual configuration of increased dead timers across the network, optimizing or improving the handling of topology changes and enhancing network reliability.

While for purposes of simplicity of explanation, the respective processes are shown and described as a series of blocks in FIG. 3A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 3B depicts an illustrative embodiment of a method 350 in accordance with various aspects described herein. Method 350 describes a process for managing topology changes during unplanned restarts in a network utilizing OSPF or IS-IS protocols. The method 350 can include, at 360, a node receiving a notification of a topology change, such as a link failure, a new link addition, a remote node restart, a metric change, or some other change in the network.

If at 370 the node is provisioned for providing abort information as described herein, then the node operating as a helper node (via the abort information) can instruct the restarting node to abort, ensuring that the network can quickly adapt to topology changes and maintain stability. Step 370 can overcome inefficiencies in current restart procedures where there is no way that a helper node can indicate a GR abort to a restarting node, and currently only shares the new LSA that it has received, exits the GR Process itself and relies on the restarting node also to exit the GR on processing the newer LSA. In one embodiment, when a restarting node is a low-end device which does not have much persistent memory which can be required to maintain the LSA DB across the restarts, the new TLV can help restarting nodes to identify if the helper node has detected any topology change. As an example, a helper node on receiving any new LSA (which points to the topology change in the network) can first send a Hello packet to the restarting node immediately, as soon as possible or within another time period, including an Abort Flag (bit) and Abort Reason in the TLV. These fields can again be reset in Hello packets once the GR exit process is completed. The updated LSA can be shared after sending this Hello packet to the restarting node so that it can take GR Abort action without wasting time on processing of newer LSAs. As described herein, this TLV can indicate: whether the GR should be “Aborted OR Not”; and if Yes, a “Reason for GR Abort.” On receiving such a Hello packet, a restarting node can immediately, as soon as possible or within another time period, process the GR Abort message and start the DB exchange afresh so that new SPF calculations can be started.

While for purposes of simplicity of explanation, the respective processes are shown and described as a series of blocks in FIG. 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Methods 300 and 350 can be utilized together in a network for improved network stability. Alternatively, one of methods 300 and 350 can be implemented on its own. Method 350 provides a number of different benefits including for use with low end devices, which may have guidelines for a user to use higher dead timer values on each of OSPF Nodes to cater to slow boot up during the OSPF GR. Through use of method 300, the user no longer needs to manually configure a higher dead timer value on so many nodes in the network.

This also eliminates a user needing to manually configure different timer values for different platforms. Further, method 350 can improve a node's (e.g., router's) detection performance during topology change events by avoiding the comparison of huge LSA Databases. This further leads to faster convergence of networks in such events.

The system and methodology described herein can be applied in either OSPF or IS-IS which are both link-state routing protocols used to determine the best path for data to travel across a network. However, they can have several differences in their operation and design:
Layer of Operation: In one embodiment, OSPF operates at the Internet Protocol (IP) layer and is specifically designed for IP networks. In contrast in one embodiment, IS-IS operates at the network layer and is not tied to any specific network protocol, making it capable of supporting multiple network layer protocols, including both IPv4 and IPv6.
Protocol Encapsulation: In one embodiment, OSPF packets are encapsulated directly within IP packets, using protocol number 89. In one embodiment, IS-IS, on the other hand, is encapsulated directly within the data link layer, which allows it to be independent of the IP layer. This encapsulation method makes IS-IS more flexible in terms of supporting different network protocols.
Network Hierarchy: In one embodiment, OSPF uses a two-level hierarchy with areas, where Area 0 (the backbone area) connects all other areas. This design helps in reducing routing overhead and improving scalability. In one embodiment, IS-IS also uses a hierarchical design but divides the network into levels (Level 1 and Level 2), where Level 1 routers communicate within an area, and Level 2 routers connect different areas.
Metric Calculation: In one embodiment, OSPF and/or IS-IS use cost as a metric to determine the best path, but the calculation of these costs can differ. In one embodiment, OSPF allows for more granular cost settings based on link bandwidth, while IS-IS uses a simpler metric system that can be manually configured.
Convergence and Scalability: In one embodiment, IS-IS is often considered more scalable than OSPF, particularly in very large networks, due to its simpler design and the ability to handle a larger number of routers and links. This scalability makes IS-IS a preferred choice for large service provider networks.
Configuration and Complexity: In one embodiment, OSPF is generally considered easier to configure and manage, with more straightforward area configurations and a more intuitive design for IP networks. In one embodiment, IS-IS, while more complex, offers greater flexibility and scalability, which can be advantageous in large and diverse network environments.
Use Cases: In one embodiment, OSPF is widely used in enterprise networks due to its ease of use and integration with IP. In one embodiment, IS-IS is more commonly used in large service provider networks where scalability and protocol independence are critical.

The IS-IS and/or OSPF protocols can have mechanisms to handle restarts, but they can differ in their approaches and implementations:
Protocol Layer and Encapsulation: In one embodiment, OSPF operates at the IP layer and uses IP encapsulation for its packets, while IS-IS operates at the network layer and is encapsulated directly within the data link layer. In one embodiment, this fundamental difference can affect how each protocol handles restarts, as IS-IS is not tied to a specific network protocol, allowing for more flexibility.
Restart Notification: In one embodiment, in OSPF Graceful Restart, a router undergoing a restart informs its neighbors by setting a “Restart” bit in the OSPF Hello packets. OSPF routers can enter helper mode via a Grace-LSA, which allows for maintaining the forwarding state and adjacency with the restarting router. In one embodiment, IS-IS uses a Restart TLV (Type-Length-Value) in its Hello packets to indicate a restart. This TLV includes information such as the remaining holding time and the restarting neighbor's ID.
Helper Mode: In one embodiment, in OSPF, neighboring routers enter a Helper mode via a Grace-LSA, where they continue to forward packets based on the last known routing information. In one embodiment, in IS-IS, the concept is similar, but the protocol uses the Restart TLV to manage the adjacency and forwarding state during the restart process.
Database Synchronization: In one embodiment, after an OSPF router restarts, it synchronizes its LSDB with its neighbors by exchanging DBD packets and LSR packets. In one embodiment, in IS-IS, the restarting router uses the Restart TLV to inform neighbors of its restart, and the neighbors help in synchronizing the LSPs to rebuild the router's database.
Grace Period: Both protocols have a grace period during which the restarting router is to complete its database synchronization, which includes one or more of the features described by the exemplary embodiments including being managed through the exchange and use of restart information and/or abort information. In one embodiment, in OSPF, this can be provided in whole or in part via the Grace LSA, while in another embodiment in IS-IS, the Restart TLV can provide in whole or in part a remaining holding time for the adjacency.
Topology Change Handling: In one embodiment, OSPF Graceful Restart can be sensitive to topology changes, which can cause the Helper mode to be exited prematurely if significant changes occur. In one embodiment, IS-IS, with its Restart TLV, can provide a more flexible mechanism to handle topology changes, allowing for more efficient management of the restart process.

Overall, while both OSPF and IS-IS have mechanisms to handle restarts without disrupting network operations, they differ in their implementation details and the specific methods used to maintain adjacency and forwarding state during the restart process. It should be understood that the mechanisms and functionality described herein can be adjusted according to features described with respect to the exemplary embodiments described herein, including restart and/or abort procedures being managed in whole or in part through the exchange (between nodes including restarting nodes and helper nodes) and use of restart information and/or abort information.

In some embodiments, rather than initiating a secondary timer upon expiry of a dead timer, another approach can be used to track the secondary time period. For example, a node can be implemented with a fixed or default dead time D, which in the prior discussion represents the time to expiry of the dead timer. Another value S can be defined which in the prior discussion corresponds to the time to expiry of the secondary timer, when started at expiry of the dead timer. The secondary time period is then the time from D to D+S. One or more the exemplary embodiments provide a specific implementation (e.g., process, components and data) for avoiding timeouts and aborts. In one or more embodiments, an additional timer (which can include an extended time value) can be implemented through various functionality, components and/or data.

Now, in some embodiments, a helper node can, in response to receiving (e.g. via a TLV) a restart time value from another node, adjust its dead timer expiry value. For example, if the received restart time value indicates the secondary time S, then the helper node can adjust its dead timer expiry value from the default value of D to D+S. Then, the helper node can perform the prescribed actions during the secondary time period from D to D+S, such as refraining from clearing neighborship and respective routing entries and maintaining traffic flow.

In another embodiment, the dead timer maintains a timed and incremental/decremental count. Rather than extending the dead timer's expiry value from D to D+S, this count can be adjusted either at initialization or at some point during operation of the timer. The adjustment is configured to extend the time to dead timer expiry by S units, thus effectively extending the time until dead timer expiry.

In other embodiments, both a dead timer and a secondary timer can be maintained, but the two timers begin counting at the same time. The dead timer expires at time D, while the secondary timer expires at time D+S.

In one or more embodiments, the secondary timer may alternatively be referred to simply as a timer, with an associated timer period. In one embodiment, operating the secondary timer can involve initiating the secondary timer based on (e.g. at) expiration of a dead timer, where the dead time period ends with expiration of the dead timer. In one embodiment, operating the secondary timer can also involve initiating the secondary timer along with (e.g. at the same time as) the dead timer. In one embodiment, operating the secondary timer can further involve modifying an existing, and possibly already running, timer (e.g. the dead timer) so that its expiration is extended. In this case, the dead time period is not necessarily explicitly tracked, but nonetheless could be defined as the (e.g. default) period between initiation and ending of the dead timer, had the dead timer not been modified.

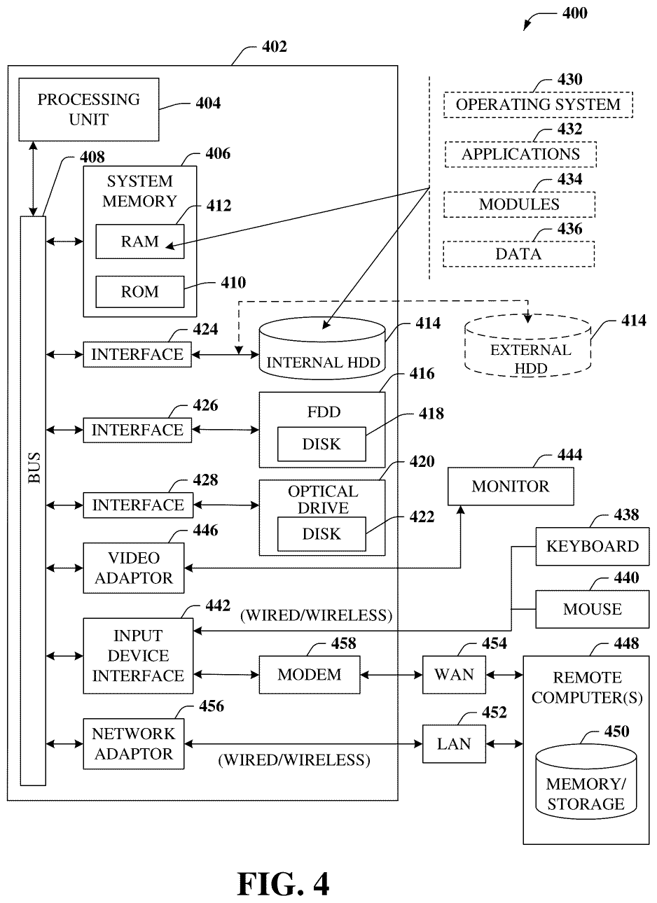

Turning now to FIG. 4, there is illustrated a block diagram of a computing environment 400 in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate in whole or in part providing a Hello packet between a first node and a second node, where the Hello packet includes one of restart information with a maximum restart timer or abort information with an abort instruction, and where the first node is operating according to one of OSPF protocol or IS-IS protocol (or another routing protocol that utilizes restart and/or abort functions).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a helper node, a Hello packet from a restarting node, wherein the Hello packet includes restart information comprising a maximum restart timer;
storing, by the helper node, the restart information;
based on the restart information, operating, by the helper node, a timer and refraining from clearing neighborship and respective routing entries during a timer period which follows expiration of a dead time period and is prior to expiration of the timer;
maintaining, by the helper node, traffic flow during the timer period to allow the restarting node to attempt to complete a restart process;
monitoring, by the helper node, for receipt of a Link-State Advertisement (LSA) at the helper node from the restarting node;
responsive to receiving the LSA within the timer period, entering, by the helper node, a restart recovery phase thereby continuing to function as the helper node for the restarting node; or responsive to expiration of the timer period prior to the receiving of the LSA, clearing, by the helper node, the neighborship and respective routing entries.

2. The method of claim 1, comprising responsive to the expiration of the timer period prior to the receiving of the LSA, initiating, by the helper node, fresh Shortest Path First (SPF) calculations.

3. The method of claim 1, wherein the restart recovery phase is one of a Graceful Restart (GR) recovery phase or a Non-Stop Forwarding phase.

4. The method of claim 1, wherein the LSA is one of a Link-State Packet (LSP) or a Grace LSA.

5. The method of claim 1, wherein the helper node is operating according to one of OSPF protocol or IS-IS protocol.

6. The method of claim 1, wherein the Hello packet comprises one of a Graceful Restart TLV (GR-TLV) or an IS-IS Restart TLV.

7. The method of claim 6, wherein the GR-TLV includes fields for an Abort instruction and an Abort description.

8. The method of claim 1, comprising:
determining, by the helper node, a network topology change; and
providing, by the helper node to the restarting node, another Hello packet including abort information responsive to the network topology change.

9. The method of claim 8, comprising:
receiving, by the helper node, another LSA, wherein the determining of the network topology change is according to the another LSA, and wherein the abort information includes an Abort instruction and a description of a reason for the Abort instruction.

10. The method of claim 9, wherein the another LSA indicates a type of topology change comprising at least one of a link failure, a new link addition, a remote node restart, a metric change, or a combination thereof.

11. A method, comprising:
providing, by a restarting node, a Hello packet to a helper node, wherein the Hello packet includes restart information with a maximum restart timer;
commencing a restart; and
commencing a recovery phase.

12. The method of claim 11, comprising:
receiving, by the restarting node from the helper node, another Hello packet including abort information responsive to a determination by the helper node of a network topology change.

13. The method of claim 11, comprising providing, by the restarting node to the helper node, a Link-State Advertisement (LSA) prior to the commencing of the recovery phase, wherein the LSA is one of a Link-State Packet (LSP) or a Grace LSA.

14. The method of claim 13, comprising receiving, by the restarting node from the helper node, an LSA Acknowledgement (ACK) prior to the commencing of the recovery phase, wherein the LSA ACK is received in response to the LSA being received by the helper node within a secondary timer period of a secondary timer initiated by the helper node, and wherein the helper node refrains from clearing neighborship and respective routing entries during the secondary timer period.

15. The method of claim 11, wherein the restarting node is operating according to one of OSPF protocol or IS-IS protocol.

16. The method of claim 11, wherein the Hello packet comprises one of a Graceful Restart TLV (GR-TLV) or an IS-IS Restart TLV.

17. The method of claim 16, wherein the GR-TLV includes fields for an Abort instruction and an Abort description.

18. A device operating as a node, comprising:
a processing system including a processor; and
a memory that stores executable instructions that, when executed by the processing system, facilitate performance of operations, the operations comprising:
providing a Hello packet to another node, wherein the Hello packet includes abort information with an abort instruction, wherein the node is operating according to one of OSPF protocol or IS-IS protocol.

19. The device of claim 18, wherein a recovery phase is aborted in response to the abort instruction.

20. The device of claim 19, wherein the operations further comprise:
determining a network topology change, wherein the providing of the Hello packet is responsive to the determination of the network topology change.
